(19) United States
(12) Patent Application Publication
(10) Pub. No.: US 2014/0144557 A1
(43) Pub. Date: May 29, 2014

(54) METHOD FOR PRODUCING LOW TEMPERATURE BAINITE STEEL CONTAINING ALUMINUM

(71) Applicant: Yanshan University, Hebei (CN)

(72) Inventors: Fucheng ZHANG, Hebei (CN); Bo LV, Hebei (CN); Tiansheng WANG, Hebei (CN); Yangzeng ZHENG, Hebei (CN); Ming ZHANG, Hebei (CN); Zhinan YANG, Hebei (CN); Chunlei ZHENG, Hebei (CN); Mao LI, Hebei (CN); Jie KANG, Hebei (CN)

(73) Assignee: Yanshan University, Hebei (CN)

(21) Appl. No.: 14/035,216

(22) Filed: Sep. 24, 2013

(30) Foreign Application Priority Data
Nov. 29, 2012 (CN) 201210504420.4

(51) Int. Cl. C21D 8/00

(52) U.S. Cl. CPC C21D 8/005
USPC 148/547

(57) ABSTRACT

A method for producing low temperature bainite steel containing aluminum may include providing an alloy steel containing aluminum, carbon, chromium, silicon, molybdenum, manganese and nickel, wherein the amount of aluminum is in the range of 0.5 to 1.5 wt. %, and the amount of carbon is in the range of 0.2 to 1.1 wt. %; smelting to convert the alloy steel into a molten steel, followed by subjecting to refining and vacuum degassing, and then subjected to rolling or forging; heating the steel to 880-950° C., cooling the steel to Mₛ+10° C. at a rate higher than 50° C./min, continuously and slowly cooling the steel from Mₛ+10° C. to Mₛ×100×C(wt %)° C., holding the steel at a temperature of 250° C. to 350° C. for 20 to 30 min, and then air cooling the steel to room temperature, holding the steel at a temperature of 180° C. to 280° C. for 60 min, and then air cooling the steel to room temperature.

### RELATED APPLICATION

This application claims the benefit of Chinese Patent Application No. 201210504420.4, filed on Nov. 29, 2012 and entitled “METHOD FOR PRODUCING LOW TEMPERATURE BAINITE STEEL CONTAINING ALUMINUM”, the contents of which are incorporated herein by reference in its entirety.

### TECHNICAL FIELD

The present invention relates generally to metallic materials, and more particularly to a low temperature bainite steel containing aluminum and a method for producing the same.

### BACKGROUND ART

Generally, materials are degraded mostly due to abrasion and fatigue. A majority of the components, such as rails, crossings, linings, bearings and gears, used in industries like metallurgy, railway, mining and mechanics become failure due to abrasion and fatigue, which causes a considerable economic loss. According to statistics, in industrially developed countries, the economic loss due to abrasion and fatigue of the mechanical equipment and parts accounts for about 4% of the total value of production in national economy. Thus, it is important to develop abrasion and fatigue resistant steel articles of high performance.

Low-carbon bainite steels exhibit excellent contact fatigue and abrasion resistance due to their high strength, high toughness and suitable hardness, and thereby become one of the ideal materials for making durable track components such as rails and crossings. Moreover, bainite steels now have been increasingly used for making crossings and rails in railway application. Medium-carbon bainite steels are abrasion resistant steels of high performance developed in the last decades. Such steels, derived from low alloy high strength steels, have a good abrasion resistance, of which the service life is several times more than that of the conventional structural steels, and accordingly become the representative abrasion resistant steels of a new generation. Currently, a variety of abrasion resistant steels of high strength have been produced in many countries. Especially, in some developed countries, steel manufacturers possess products in their own series and own standards, such as Hardox series (SSAB Oxelosund, Sweden), Xar series (ThyssenKrupp, Germany), Everhard series (JFE, Japan), and the like. In China, a majority of the abrasion resistant steels of high strength are Mn—Si and Cr—Mo—V—B series. However, most of such steels have a quenched and tempered martensite microstructure formed by subjecting to quenching and tempering in the rolling process, and only a few has a compounded microstructure with continuously transformed bainite, martensite and retained austenite formed by controlled rolling and controlled cooling technique. As is well known, bearings are key basic components in mechanical equipment, which are required to have excellent abrasion resistance and high contact fatigue resistance. The quality of bearings has a direct effect on the service life of the whole equipment, and are mainly determined by the materials and the heat treatment processes. Conventional bearings generally have a tempered martensite microstructure with a high hardness but a low toughness. Recently, high-carbon bainite bearing steels have been increasingly developed in order to further improve the service life of bearings.

The technologies for producing bainite steel can be found in many patent documents. For example, bainite steel crossings and rails and methods for producing the same are described in CN. Pat. Nos.: ZL200910227861.2 and CN101423916A, W09622396A to Professor Bhadeshia (a famous material scientist from the University of Cambridge, United Kingdom); abrasion resistant bainite steel sheets and methods for producing the same are described in WO02004048620A1 (CN1714160A) to Beguinot (Creusot, France), and CN. Pat. No. ZL200510079346.6; methods for producing bainite bearing steels are described in CN. Pat. No. ZL200610102027.7, SE. Pat. No. SE9702852-6(CN1214368A) to Ovako, Sweden and WO0063450 (CN1347462A) to SKF, Holland. However, these technologies still fail to ensure the completion of a sufficient bainite transformation in steels and thereby fail to provide bainite steels with excellent mechanical properties of high strength, hardness, toughness, ductility and the like.

### DISCLOSURE OF THE INVENTION

In accordance with one aspect of the present invention, a method for producing a low temperature bainite steel containing aluminum is provided. Said method features a simple processes and a sufficient bainite transformation, and the microstructure produced has a high dislocation density and a lath with a broad thickness range. According to the present invention, the method comprises the steps of:

(1) providing a steel composition, comprising 0.2 to 1.1 wt. % of carbon, 0.5 to 1.5 wt. % of aluminum, 0.5 to 1.5 wt. % of silicon, 0.2 to 2.0 wt. % of manganese, 1.0 to 2.0 wt. % of chromium, 0 to 1.0 wt. % of nickel, 0.2 to 0.5 wt. % of molybdenum, less than 0.01 wt. % of titanium, less than 0.03 wt. % of vanadium, less than 0.01 wt. % of niobium, less than 0.02 wt. % of sulfur, less than 0.02 wt. % of phosphorus, less than 0.001 wt. % of oxygen, less than 0.0001 wt. % of hydrogen, and the balance iron, wherein the collective amount of aluminum and silicon is in the range of 1.5 to 2.5 wt. %;

(2) smelting in an electric furnace or an oxygen converter to convert the composition into an molten steel, which is then subjected to conventional refining and vacuum degassing, and followed by subjecting to conventional rolling or forging; and

(3) subjecting the steel to the final heat treatment as follows:

a. austenitizing the thus obtained steel by heating to 880-950° C.,

b. cooling the steel to Mₛ+10° C. at a rate higher than 50° C./min,

c. continuously and slowly cooling the steel from Mₛ+10° C. to Mₛ−100×C(wt. %)° C., wherein C is the amount of carbon (in wt. %) in the steel composition,

d. subjecting the steel to a stabilization process to stabilize the austenite by holding the steel at a temperature of 250° C. to 350° C. for 20 to 30 min, and then air cooling it to room temperature, and

e. subjecting the steel to a tempering process by holding the steel at a temperature of 180° C. to 280° C. for 60 min, and then air cooling it to room temperature.

The present invention is superior to the prior art in the following aspects:

1. In the heat treatment process, the continuous cooling within an intermediate temperature range is carried out from Mₛ+10° C. to Mₛ−100×C(wt%)° C. at a very low rate, which ensures a sufficient bainite transformation in steels;

2. In the heat treatment process, an additional retained austenite stabilizing process is incorporated, which ensures the stability of the retained austenite during the entire service period of steels, which facilitates the improvement of the fatigue resistance of steels;

3. The low temperature bainite steel containing aluminum thus produced according to the present invention has a dual-phase microstructure containing a bainite-ferrite lath with a thickness varying from 20 to 300 nm, and the retained austenite thin film layers distributed therein, and thereby exhibits the most excellent mechanical properties of high strength, hardness, toughness, ductility and the like; and

4. Steels having the structure containing the low temperature bainite steel containing aluminum can be used for making mechanical components like durable rails and crossings, abrasion resistant steel sheets of high performance, bearings of high quality and the like.

### DETAILED DESCRIPTION OF THE EMBODIMENTS

### EXAMPLE 1

The production of a low-carbon bainite steel rail

A molten steel was prepared in an oxygen converter by smelting, which was then subjected to refining in a LF furnace, vacuum degassing by RH process and continuous casting to form a steel billet. The steel billet comprised of 0.20 wt. % of carbon, 0.50 wt. % of aluminum, 1.40 wt. % of silicon, 0.98 wt. % of manganese, 1.52 wt. % of chromium, 0.52 wt. % of nickel, 0.35 wt. % of molybdenum, 0.01 wt. % of sulfur, 0.02 wt. % of phosphorus, and the balance iron. Next, the continuously casted steel billet was subjected to hot rolling cogging, wherein the initial rolling temperature was 1150° C., and the finishing temperature was 920° C. A standard steel rail 60 was formed by rolling with a rolling ratio of 12. After measurements, it was determined that the Mₛ temperature of the thus produced steel rail was 400° C. Then, the steel rail was heated to 950° C. for austenitizing, cooled to 410° C. at a rate of 55° C./min, cooled from 410° C. to 380° C. at a rate of 0.6° C./min, held at 350° C. for 20 min, and air cooled to room temperature. Finally, the steel rail was heated to 280° C. and held for 60 min, and then air cooled to room temperature. A longitudinal testing sample was taken from the section of the steel rail at a depth of 20 mm from the rail surface. The mechanical properties of the testing sample were tested and shown as follows: σ_{b}=1330 MPa, σ_{0.2}=1105 MPa, δ₅=18%, α_{KU}=175 J/cm², α_{KU(-40° C.)}=92 J/cm², 41 HRC.

### EXAMPLE 2

The production of a medium-low carbon bainite steel crossing

A molten steel was prepared in an oxygen converter by smelting, which was then subjected to refining in a LF furnace, vacuum degassing by VD process and continuous casting to form a steel billet. The steel billet comprised of 0.35 wt. % of carbon, 0.98 wt. % of aluminum, 1.02 wt. % of silicon, 1.36 wt. % of manganese, 1.0 wt. % of chromium, 1.0wt. % of nickel, 0.5 wt. % of molybdenum, 0.008 wt. % of titanium, 0.0011wt. % of vanadium, 0.008wt. % of niobium, 0.006 wt. % of sulfur, 0.012 wt. % of phosphorus, 0.0008 wt. % of oxygen, 0.00008 wt. % of hydrogen and the balance iron. Next, the continuous casted steel billet was subjected to hot rolling cogging, wherein the initial rolling temperature was 1170° C., and the finishing temperature was 950° C. The rolled steel billet was formed with a cross dimensions of 120×190 mm and a rolling ratio of 7. After measurements, it was determined that the Mₛ temperature of the thus produced steel billet was 350° C. Then, the steel billet was heated to 940° C. for austenitizing, cooled to 360° C. at a rate of 60° C./min, cooled from 360° C. to 320° C. at a rate of 0.7° C./min, held at 320° C. for 25 min and then air cooled to room temperature. Finally, the steel billet was heated to 260° C. and held for 60 min, and then air cooled to room temperature. A testing sample was taken from the section of the steel rail at a depth of 30 mm from the surface of the rolled billet. The mechanical properties of the testing sample were tested and shown as follows: σ_{b}=1551 MPa, σ_{0.2}=1276 MPa, δ₅=16%, α_{KU}=132 J/cm², 46 HRC.

### EXAMPLE 3

The production of a medium-carbon abrasion resistant bainite steel sheet

A molten steel was prepared in an oxygen converter by smelting, which was then subjected to refining in a LF furnace, vacuum degassing by RH process and continuous casting to form a steel billet. The steel billet comprised of 0.48 wt. % of carbon, 0.76 wt. % of aluminum, 1.50 wt. % of silicon, 2.0 wt. % of manganese, 2.0 wt. % of chromium, 0.43 wt. % of molybdenum, 0.019 wt. % of sulfur, 0.019 wt. % of phosphorus and the balance iron. The rolled abrasion resistant steel sheet has a thickness of 18 mm and a width of 3 m. After measurement, it was determined that the Mₛ temperature of the thus produced steel sheet was 250° C. Then, the steel sheet was heated to 920° C. for austenitizing, cooled to 260° C. at a rate of 70° C./min, cooled from 260° C. to 202° C. at a rate of 1.0° C./min, directly held at 300° C. for 30 min and then air cooled to room temperature. Finally, the steel sheet was heated to 250° C. and held at 250° C. for 60 min, and then air cooled to room temperature. The mechanical properties of the steel sheet were tested and shown as follows: σ_{b}=1721 MPa, σ_{0.2}=1446 MPa, δ₅=10%, α_{KU}=98 J/cm², 56 HRC.

### EXAMPLE 4

The production of a high-carbon bainite bearing steel

A molten steel was prepared in an oxygen converter by smelting, which was then subjected to refining in a LF furnace, vacuum degassing by VD process and continuous casting to form a steel billet. The steel billet comprised of 1.10 wt. % of carbon, 1.50 wt. % of aluminum, 0.50 wt. % of silicon, 0.20 wt. % of manganese, 1.52 wt. % of chromium, 0.20 wt. % of molybdenum, 0.005 wt. % of sulfur, 0.008 wt. % of phosphorus, 0.0008 wt. % of oxygen, 0.0001 wt. % of hydrogen and the balance iron. Next, the steel billet was subjected to a plastic thermal deformation by a conventional forging process with a forging ratio of 9. After measurement, it was determined that the Mₛ temperature of the thus produced steel was 200° C. after having subjected to austenitizing at 900° C. Then, the steel sheet was heated to 900° C. for austenitizing, cooled to 210° C. at a rate of 60° C./min, cooled from 210° C. to 100° C. at a rate of 0.6° C./min, the furnace temperature was directly elevated to 250° C. and held for 25 min, and then air cooled to room temperature. Finally, the steel was heated to 180° C. and held for 60 min, and then air cooled to room temperature. The mechanical properties of the entire hard bainite bearing thus produced were tested and shown as follows: 62 HRC, σ_{b}=2400 MPa, σ_{0.2}=2186 MPa, δ₅=5%, α_{KU}=22 J/cm². The rolling contact fatigue resistance of the resulted bearing was increased by 1.2 times as compared to that of the conventional quenched and tempered martensite bearing steel GCr15.

### EXAMPLE 5

The production of a medium-low carbon bainite steel crossing

A molten steel was prepared in an oxygen converter by smelting, which was then subjected to refining in a LF furnace, vacuum degassing by RH process and continuous casting to form a steel billet. The steel billet comprised of 0.30 wt. % of carbon, 0.58 wt. % of aluminum, 1.0 wt. % of silicon, 1.67 wt. % of manganese, 1.32 wt. % of chromium, 0.42 wt. % of nickel, 0.40 wt. % of molybdenum, 0.008 wt. % of titanium, 0.0009 wt. % of vanadium, 0.007 wt. % of niobium, 0.008 wt. % of sulfur, 0.010 wt. % of phosphorus, 0.0008 wt. % of oxygen, 0.00009 wt. % of hydrogen and the balance iron. Next, the continuous casted steel billet was subjected to hot rolling cogging, wherein the initial rolling temperature was 1180° C., and the finishing temperature was 960° C. The rolled steel billet has a cross dimensions of 120×190 mm and a rolling ratio of 8. After measurements, it was determined that the Mₛ temperature of the thus produced steel billet was 340° C. Then, the steel billet was heated to 930° C. for austenitizing, cooled to 350° C. at a rate of 65° C./min, cooled from 350° C. to 310° C. at a rate of 0.8° C./min, held at 310° C. for 27 min, and then air cooled to room temperature. Finally, the steel billet was heated to 250° C. and held for 60 min, and then air cooled to room temperature. A testing sample was taken from the section of the steel rail at a depth of 30 mm from the surface of the rolled billet. The mechanical properties of the testing sample were tested and shown as follows: σ_{b}=1389 MPa, σ_{0.2}=1159 MPa, δ₅=17%, α_{KU}=151 J/cm², 43 HRC.

### EXAMPLE 6

The production of a high-carbon bainite bearing steel

A molten steel was prepared in an oxygen converter by smelting, which was then subjected to refining in a LF furnace, vacuum degassing by RH process and continuous casting to form a steel billet. The steel billet comprised of 0.98 wt. % of carbon, 1.00 wt. % of aluminum, 1.22 wt. % of silicon, 0.46 wt. % of manganese, 1.61 wt. % of chromium, 0.25 wt. % of molybdenum, 0.004 wt. % of sulfur, 0.011 wt. % of phosphorus, 0.0008 wt. % of oxygen, 0.00009 wt. % of hydrogen and the balance iron. Next, the steel billet was subjected to plastic thermal deformation by a conventional forging process with a forging ratio of 8. After measurements, it was determined that the Mₛ temperature of the thus produced steel was 200° C. after having subjected to austenitizing at 880° C. Then, the steel sheet was heated to 880° C. for austenitizing, cooled to 210° C. at a rate of 60° C./min, cooled from 210° C. to 100° C. at a rate of 0.6° C./min; the furnace temperature was directly elevated to 260° C. and the steel sheet was held at 260° C. for 28 min, and then air cooled to room temperature. Finally, the steel was heated to 180° C. and held for 60 min, and then air cooled to room temperature. The mechanical properties of the entirely hard bainite bearing thus produced were tested and shown as follows: HRC61, σ_{b}=2277 MPa, σ_{0.2}=2008 MPa, δ₅=5%, α_{KU}=24 J/cm². The rolling contact fatigue resistance of the resulted bearing was increased by 1.3 times as compared to that of the conventional quenched and tempered martensite bearing steel GCr15.

Although the present invention has been described and illustrated in detail, it is clearly understood that the same is by way of illustration and example only and is not to be taken by way of limitation, the spirit and scope of the present invention being limited only by the terms of the appended claims.

What is claimed is:

1. A method for producing a low temperature bainite steel containing aluminum, wherein the method comprises the steps of:
(1) providing a steel composition, comprising 0.2 to 1.1 wt. % of carbon, 0.5 to 1.5 wt. % of aluminum, 0.5 to 1.5 wt. % of silicon, 0.2 to 2.0 wt. % of manganese, 1.0 to 2.0 wt. % of chromium, 0 to 1.0 wt. % of nickel, 0.2 to 0.5 wt. % of molybdenum, less than 0.01 wt. % of titanium, less than 0.03 wt. % of vanadium, less than 0.01 wt. % of niobium, less than 0.02 wt. % of sulfur, less than 0.02 wt. % of phosphorus, less than 0.001 wt. % of oxygen, less than 0.0001 wt. % of hydrogen, and the balance iron, wherein the collective amount of aluminum and silicon is in the range of 1.5 to 2.5 wt. %;
(2) smelting in an electric furnace or an oxygen converter to convert the composition into an molten steel, which is then subjected to refining and vacuum degassing, followed by subjecting to rolling or forging; and
(3) subjecting the steel to the final heat treatment as follows:
a. austenitizing the thus obtained steel by heating to 880-950° C.,
b. cooling the steel to Ms+10° C. at a rate higher than 50° C./min,
c. continuously and slowly cooling the steel from Mₛ+10° C. to Mₛ−100×C wt. %° C.,
d. subjecting the steel to a stabilization process to stabilize the austenite by holding the steel at a temperature of 250° C. to 350° C. for 20 to 30 min, and then air cooling it to room temperature, and
e. subjecting the steel to a tempering process by holding the steel at a temperature of 180° C. to 280° C. for 60 min, and then air cooling it to room temperature.
